(19) United States
(12) Patent Application Publication
(10) Pub. No.: US 2008/0175672 A1
(43) Pub. Date: Jul. 24, 2008

(54) Riser with axially offset dog-type connectors

(75) Inventor: Thomas A. Fraser, Spring, TX (US)

Correspondence Address: BRACEWELL & GIULIANI LLP, P.O. BOX 61389, HOUSTON, TX, 77208-1389, US

(73) Assignee: Vetco Gray Inc.

(21) Appl. No.: 11/655,709

(22) Filed: Jan. 19, 2007

(51) Int. Cl. F16L 1/12

(52) U.S. Cl. 405/170

(57) ABSTRACT

An offshore riser is made up of riser segments connected together. Each riser segment has a central pipe with a box on one end and a pin on the other end. The pin has two grooved profiles extending circumferentially around it. The box has a first tier of connectors mounted to and spaced circumferentially around the box. The box also has a second tier of connectors mounted to and spaced circumferentially around the box, but at a different elevation. The first and second tier connectors alternate with each other. Each of the connectors includes a dog and a screw for moving the dog into engagement with one of the profiles when the screw is rotated.

### FIELD OF THE INVENTION

This invention relates in general to offshore risers for oil and gas wells, and in particular to a dog-type drilling riser wherein the dogs are arranged in multiple tiers at different elevations.

### BACKGROUND OF THE INVENTION

Drilling risers are commonly used for offshore oil and gas well drilling operations. A drilling riser is made up of segments or joints that are secured to each other and lowered into the sea from the drilling vessel. Different types of connectors between the riser segments are used. One type employs bolts for bolting flanges of the mating connectors to each other. Another type has a pin member on one end that inserts into a box member of the next riser segment. Dogs are spaced around the box, each dog being radially movable into engagement with a grooved profile on the pin. Normally, a screw for each dog causes the radial movement when rotated.

Operators are drilling wells in increasingly deeper waters. Deeper water places more tensile loading on the riser segments and their connectors. Also, operators are now proposing to drill with the main blowout preventer on the drilling vessel, rather than at the subsea wellhead as in the prior art. Locating the blowout preventer at the surface requires the drilling riser to be able to withstand higher pressure than in the prior art, which further increases the loading on the connectors between the riser segments.

One solution with a dog-type riser would be to utilize more dogs. However, because a certain amount of supporting metal is required for each dog, in the prior art adding more dogs requires a greater diameter for the drilling riser. Operators prefer to have a slender drilling riser to reduce the expense and the weight of the drilling riser.

### SUMMARY OF THE INVENTION

The riser of this invention is made up of a plurality of tubular members, each having a box on one end and a pin on the opposite end for connection to the other tubular members. The box has first and second sets of windows, each set of windows being spaced circumferentially about the box. The first set of windows is located at a closer axial distance to an end of the box than the second set. A dog or locking element is located in each of the windows. Each locking element is radially movable inward and outward for engaging and disengaging the pin of one of the tubular members.

In the preferred embodiment, the first windows are staggered around the circumference of the box relative to the second windows. That is, when viewed in sectional planes perpendicular to the riser axis, each of the second windows would appear between two of the first windows. Preferably, the circumferential distance between the windows of the first set is uniform and is the same as the circumferential distance between the windows of the second set. The diameter of the box at the first set of windows is thus the same as at the second set of windows.

In the preferred embodiment, the means for moving the locking elements radially inward comprises a rotatable screw, which is operatively coupled to each of the locking elements. When the screw is rotated, the locking element will move radially.

Each pin has two separate circumferentially extending grooved profiles, one above the other. Each grooved profile extends circumferentially around the pin. The grooved profiles are spaced apart from each other so that one set of locking elements will engage one grooved profile while the other set engages the other.

In the preferred embodiment, the connections are axially preloaded. This is handled by providing each pin with a flange that contacts the rim of the box. The locking elements have ramp surfaces that are angled and positioned so as to provide an axial preload between the flange and the rim when the locking elements engage the grooved profiles.

### BRIEF DESCRIPTION OF THE DRAWINGS

FIG. 1 is a sectional view illustrating a riser segment constructed in accordance with the invention.

FIG. 2 is a top plan view of the riser segment of FIG. 1.

FIG. 3 is an enlarged sectional view of the riser segment of FIG. 1, taken along the line 3-3 of FIG. 4.

FIG. 4 is an enlarged sectional view of an upper portion of the riser segment of FIG. 1, showing also the pin of another riser segment made up with the box of the lower riser segment.

FIG. 5 is an enlarged partial sectional view of a portion of the riser of FIG. 4, but showing an alternate embodiment that contains a metal-to-metal seal.

### DETAILED DESCRIPTION OF THE INVENTION

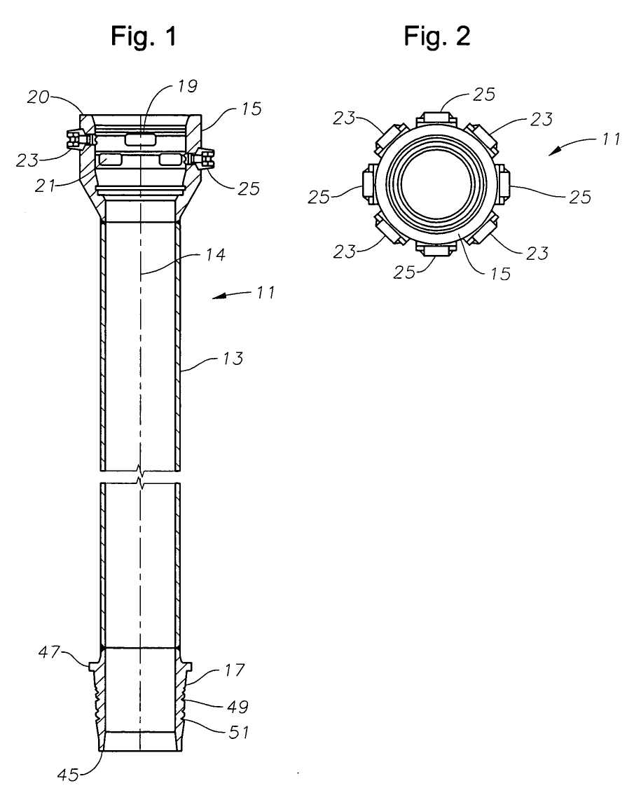

FIG. 1 shows a riser segment 11 for connection into an offshore drilling riser. Riser segment 11 has a tubular central member or pipe 13 with a longitudinal axis 14. Riser segment 11 has a box 15 on one end and a pin 17 on the opposite end. Normally, box 15 and pin 17 are separately formed and welded to tubular member 13.

Box 15 has a greater wall thickness and greater inner diameter than pipe 13. The inner diameter of box 15 is configured to closely receive the pin 17 of the next upper riser segment 11, as illustrated in FIG. 4. The terms “upper” and “lower” are used herein for convenience only, because riser segment 11 could be inverted so that box 15 is located on the lower end. Box 15 has a rim 20 at its upper end and an internal upward facing shoulder 22 near its lower end.

Box 15 has an upper tier or set of windows 19. Windows 19 extend through the side wall of box 15 and are elongated in a circumferential direction in this example. Each window 19 has a greater circumferential width than axial height. Each of the windows 19 is located the same distance from rim 20. Also, the circumferential distance between each window 19 is uniform. In this example, there are four upper tier windows 19, each having its center-point 90 degrees from the center-point of an adjacent window 19.

Box 15 also has a second tier or set of windows 21 located below upper tier windows 19. Lower tier windows 21 are preferably identical to upper tier windows 19, but are spaced a farther distance from box rim 20 than first windows 19. Second tier windows 21 are also uniformly spaced, and the circumferential spacing is the same as between upper windows 19. The diameter of box 15 at upper tier windows 19 is the same as at lower tier windows 21. There is the same number of lower tier windows 21 as upper tier windows 19. Upper and lower tier windows 19, 21 are staggered relative to each other, with the center-point of each lower tier window 21 being on a vertical line that extends equally between two of the upper tier windows 19.

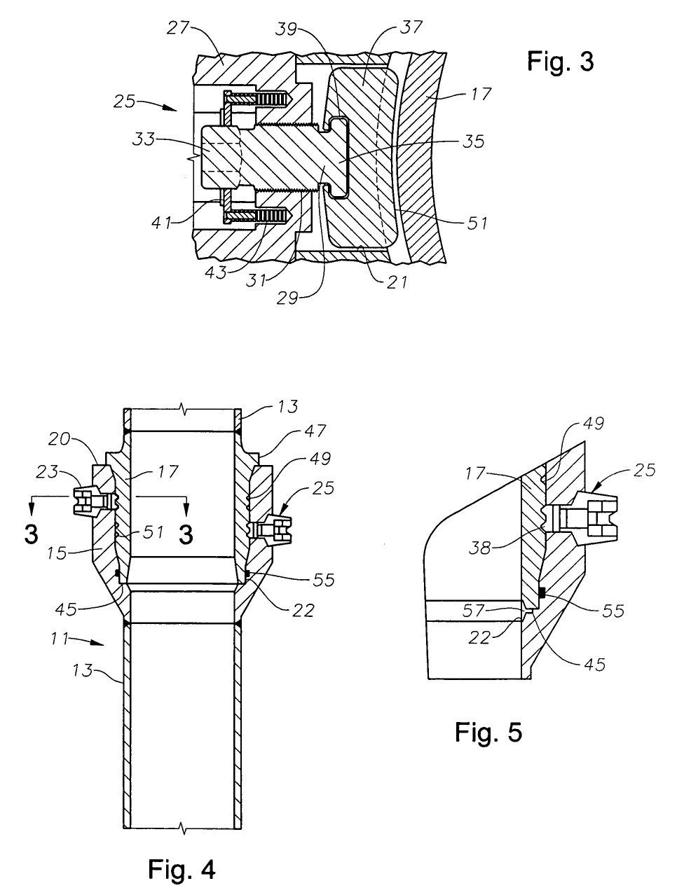

An upper connector 23 is mounted to each upper tier window 19. A lower connector 25 is mounted to each lower tier window 21. As shown in FIG. 2, lower connectors 25 are located between each upper connector 25 in a staggered fashion, but at a lower tier or elevation. Connectors 23, 25 are preferably identical and may be of a variety of types. FIG. 3 illustrates one example of one of the lower connectors 25, and the upper connectors 23 will appear the same. Lower connector 25 has a connector body 27 that stationarily mounts to box 15 in one of the lower windows 21. A screw 29 extends radially through a hole in connector body 27. Screw 29 and the hole in connector body 27 have mating threads 31. Screw 29 has a drive head 33 on its outer end that is engagable by a wrench for rotating screw 29. In this example, drive head 33 comprises a polygonal or hex head formed on the exterior of drive head 33. Each screw 29 has an inner engaging end 35 that comprises a circular flange.

A dog or locking element 37 has a recess on its outer end that rotatably receives engaging end 35. Locking element 37 preferably has a width and height slightly less than one of the windows 21. Locking element 37 moves radially relative to axis 14 (FIG. 1) when screw 29 is rotated. Locking element 37 has at least one ramp or tooth 38 on its inner end. In the preferred embodiment, each locking element has two teeth 38, one above the other as shown in FIG. 5. In the example of FIG. 5, the lower tooth 38 protrudes radially inward slightly more than the upper one, but this configuration may vary.

In the example of FIG. 3, a retainer plate 41 closely fits around polygonal drive head 33 to prevent screw 29 from rotating when retainer plate 41 is in the locked position shown in FIG. 3. Retainer plate 41 can be pushed radially inward from the locked position to allow rotation of screw 29. Springs 43 urge retainer plate 41 to the outer locked position.

Referring again to FIG. 1, pin 17 has a nose 45 on its lower end. An exterior flange 47 is preferably formed on pin 17 near its upper end for contact with rim 20 of box 15 of the next lower riser segment 11. Pin 17 has an upper grooved profile 49 and a lower grooved profile 51, each of which extends circumferentially completely around pin 17. Profiles 49, 51 are spaced one above the other so as to receive teeth 38 of locking elements 37 (FIG. 5) of upper and lower connectors 23, 25, respectively. In this example, each grooved profile 49 comprises two grooves, one above the other and the upper one being of shallower depth than the lower one, as illustrated in FIG. 5. Preferably upper grooved profile 49 is identical to lower grooved profile 51.

Referring to FIGS. 4 and 5, an elastomeric seal 55 seals between pin 17 and box 15. Seal 55 in this example is located within a mating groove in box 15. Seal 55 seals against the exterior of pin 17 at a point between nose 45 and lower grooved profile 51 to prevent leakage from the interior of riser pipe 17 to the exterior.

In the alternate embodiment of FIG. 5, in addition to elastomeric seal 55, a metal seal ring 57 seals between an inner bevel formed on nose 45 and a bevel formed on box shoulder 22. Seal ring 57 has conical seal surfaces on its outer side for sealing engagement with the bevels on nose 45 and on box shoulder 22. Seal ring 57 optionally may have an outward extending rib that located between nose 45 and shoulder 22 but does not form a seal.

To connect the riser segments 11, a lower one of the riser segments 11 will be suspended at a riser make-up floor on a drilling rig (not shown). An upper riser segment 11 is lowered downward, and its pin 17 stabs into box 15 of the lower riser segment 11. The operator rotates screws 29 (FIG. 3) of upper connectors 23 to cause them to engage upper grooved profile 49. The operator rotates screws 29 of lower connectors 25 to cause them to engage lower grooved profile 51. When engaging, teeth 38 will enter the grooves of each profile 49, 51. The angles of teeth 38 and the axial positioning of locking elements 37 are selected so that an axial downward component is applied to pin 17, causing flange 47 to preload axially against rim 20 of box 15. Preferably nose 45 does not preload against shoulder 22 in either the embodiment of FIGS. 1-4 or the embodiment of FIG. 5. In the embodiment of FIG. 5, however, nose 45 will seal against an outward-facing conical surface on metal seal 57.

The invention has significant advantages. Placing the dogs in two tiers and staggering them relative to each other allows more connectors for a given riser diameter than could otherwise be employed. The additional connectors do not require an increase in box diameter. The two tiers of dogs can exert preload forces on the connection to provide a high-strength, small-diameter riser.

While the invention has been shown in only two of its forms, it should be apparent to those skilled in the art that it is not so limited, but is susceptible to various changes without departing from the scope of the invention. For example, the dogs could be moved radially by other means than a rotatable screw. In one other configuration, an axially movable cam ring could engage cam surfaces formed on the outer ends of the dogs so that moving the ring axially would cause radial movement of the dogs.

I claim:

1. An offshore riser, comprising:
a plurality of tubular members, each having an axis, a box on one end and pin on an opposite end for connection to other of the tubular members;
the box having first and second sets of windows, each set of windows spaced circumferentially around the box, the first set of windows being located at a closer axial distance to an end of the box that the second set; and
a plurality of locking elements, each located in one of the windows and being radially movable inward and outward for engaging and disengaging the pin of one of the tubular members.

2. The riser according to claim 1, wherein the first windows are staggered around the circumference of the box relative to the second windows.

3. The riser according to claim 1, wherein:
the windows of the first set of windows are spaced circumferentially apart from each other a selected distance; and
the windows of the second set of windows are spaced circumferentially apart from each other the same selected distance.

4. The riser according to claim 1, further comprising:
a rotatable screw operatively coupled to each of the locking elements for moving the locking elements radially when the screws are rotated.

5. The riser according to claim 1, further comprising:
first and second grooved profiles extending circumferentially around each of the pins and spaced axially apart from each other for engagement by the locking elements of the box of an adjacent one of the tubular members.

6. The riser according to claim 1, wherein:
the pin of each of the tubular members has a nose;
the box of each of the tubular members has an internal shoulder; and
a metal-to-metal seal is located between the nose and the internal shoulder.

7. The riser according to claim 1, wherein:
the pin has an external flange that contacts a rim of the box of an adjacent one of the riser segments; and
the locking elements are configured so as to exert an axial component on the grooved profiles when engaging the grooved profiles so as to preload the flange against the rim of the box.

8. The riser according to claim 1, wherein the box has an internal diameter at the first set of windows that is the same as an internal diameter at the second set of windows.

9. An offshore riser formed by a plurality of riser segments connected together, each of the riser segments, comprising:
a tubular member having a box on one end and a pin on the other for reception within the box of an adjacent one of the riser segments;
a pair of grooved profiles extending circumferentially around the pin;
a plurality of first tier connectors mounted to and spaced circumferentially around the box a selected circumferential distance apart from each other and a selected axial distance from an end of the box;
a plurality of second tier connectors mounted to and spaced circumferentially around the box the same selected circumferential distance as the first tier connectors but at a greater axial distance from the end of the box than the selected axial distance, each of the second tier connectors alternating with one of the first tier connectors when viewed in sectional planes perpendicular to an axis of the tubular member; and
each of the first and second tier connectors comprising a dog and a screw, wherein rotating the screw causes the dog to move radially inward and outward into and out of engagement with one of the grooved profiles.

10. The riser according to claim 9, wherein:
each of the pins has a nose;
each of the boxes has an internal shoulder; and
a metal ring seals between the nose and the internal shoulder.

11. The riser according to claim 9, wherein each of the grooved profiles comprises a plurality of grooves and each of the dogs has a plurality of teeth that engage the grooves.

12. The riser according to claim 9, wherein:
each of the pins has an external flange that contacts a rim of the box of an adjacent one of the riser segments; and
the dogs are configured so as to exert an axial component on the grooved profiles when engaging the grooved profiles so as to preload the flange against the rim of the box.

13. The riser according to claim 9, wherein the box has an internal diameter at the first tier connectors that is the same as at the second tier connectors.

14. A method of connecting a first riser segment to a second riser segment, comprising:
providing the first riser segment with a pin having a pair of grooved profiles, each of the profiles extending circumferentially around the pin;
providing the second riser segment with a box having upper and lower tiers of locking elements, the locking elements in each tier being circumferentially spaced apart from each other, one of the tiers being spaced closer to an end of the box than the other tier;
inserting the pin of the first riser segment into the box of the second riser segment; then moving the locking elements of the upper tier into engagement with one of the grooved profiles and the locking elements of the lower tier into engagement with the other of the grooved profiles.

15. The method according to claim 14, wherein the step of moving the locking elements comprises moving the locking elements radially relative to an axis of each of the riser segments.

16. The method according to claim 14, wherein the step of moving the locking elements comprises rotating a screw associated with each of the locking elements.
